(19) United States
(12) Patent Application Publication
(10) Pub. No.: US 2009/0053438 A1
(43) Pub. Date: Feb. 26, 2009

(54) Airtight ball and a method of fabricating the airtight ball

(75) Inventor: Chun-Nan Lin, Taipei (TW)

Correspondence Address: CHARLES E. BAXLEY, ESQUIRE, 90 JOHN STREET, SUITE 309, NEW YORK, NY, 10038, US

(73) Assignee: Yuan Chi Sports Enterprise Co., Ltd.

(21) Appl. No.: 11/895,379

(22) Filed: Aug. 24, 2007

(51) Int. Cl. B29D 22/02

(52) U.S. Cl. 428/35.6; 427/379

(57) ABSTRACT

An airtight ball has an inner bladder, a sealing layer, a wound layer, a rubber layer and an outer leather covering. The inner bladder is a hollow, resilient sphere and has an inner space and an outer surface. The sealing layer is applied to the outer surface of the inner bladder and has a rubber glue layer, a polyvinyl alcohol (PVOH) layer and a rubber balloon. The rubber glue layer fills in air bubbles or holes formed in the outer surface of the inner bladder. The a PVOH layer forms a thin, airtight membrane on the rubber glue layer, keeps air from leaking out of the inner space of the inner bladder and further maintains roundness and increases bouncing ability of the ball. The rubber balloon is a thin layer of rubber attached to the PVOH layer. The wound layer is wound around the rubber balloon that keeps the wound layer from cutting the PVOH and stabilizes the wound layer. The present invention not only prevents air leakage but also increases the ball's roundness and strength.

### BACKGROUND OF THE INVENTION

1. Field of the Invention

The present invention relates to an airtight ball, especially to an airtight ball having an airtight layer to virtually eliminate air leakage and increase roundness of the ball and a method of fabricating the ball.

2. Description of the Related Art

With reference to FIG. 1, a conventional basketball (5) comprises an inner bladder (51), a nylon yarn-wound layer (52), a rubber layer (53) and an outer leather covering (54). The inner bladder (51) is the innermost component of the basketball and has an inner space (511) and an outer surface. The inner space (511) of the inner bladder (51) is filled with air. The nylon yarn-wound layer (52) is wound around the outer surface of the inner bladder (51) and increases the basketball's roundness and strength. The rubber layer (53) is attached to the nylon yarn-wound layer (52). The outer leather covering (54) is attached to the rubber layer (53) to complete the basketball.

However, the conventional basketball has a few shortcomings. One of the biggest problems is that the conventional basketball usually cannot maintain its roundness for a long time. After using the basketball for a while, air in the inner space (511) of the inner bladder (51) leaks out, and the basketball loses its roundness. Therefore, a basketball with significantly improved airtight features has been discussed.

### SUMMARY OF THE INVENTION

The objective of the present invention is to provide an airtight ball with improved airtight features.

An airtight ball in accordance with the present invention comprises an inner bladder, a sealing layer, a wound layer, a rubber layer and an outer leather covering. The inner bladder is a hollow, resilient sphere and has an inner space and an outer surface. The sealing layer is applied to the outer surface of the inner bladder and has a rubber glue layer, a polyvinyl alcohol (PVOH) layer and a rubber balloon. The rubber glue layer fills in air bubbles or holes formed in the outer surface of the inner bladder. The PVOH layer forms a thin, airtight membrane on the rubber glue layer, keeps air from leaking out of the inner space of the inner bladder and further maintains roundness and increases bouncing ability of the ball. The rubber balloon is a thin layer of rubber attached to the PVOH layer. The wound layer is wound around the rubber balloon that keeps the wound layer from cutting the PVOH and stabilizes the wound layer. The present invention not only prevents air leakage but also increases the ball's roundness and strength.

Other objectives, advantages and novel features of the invention will become more apparent from the following detailed description when taken in conjunction with the accompanying drawings.

### BRIEF DESCRIPTION OF THE DRAWINGS

FIG. 1 is a perspective cross sectional view of a conventional ball;

FIG. 2A is a perspective cross sectional view of an airtight ball in accordance with the present invention; and

FIG. 2B is an enlarged cross sectional view of the airtight ball in FIG. 2A.

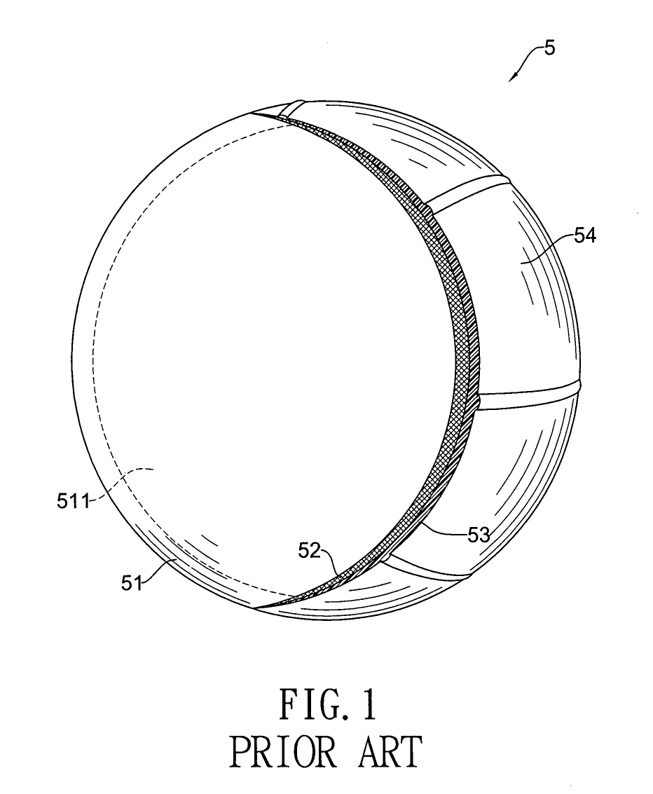

### DETAILED DESCRIPTION OF THE PREFERRED EMBODIMENTS

The invention comprises an airtight ball and a method of fabricating the ball.

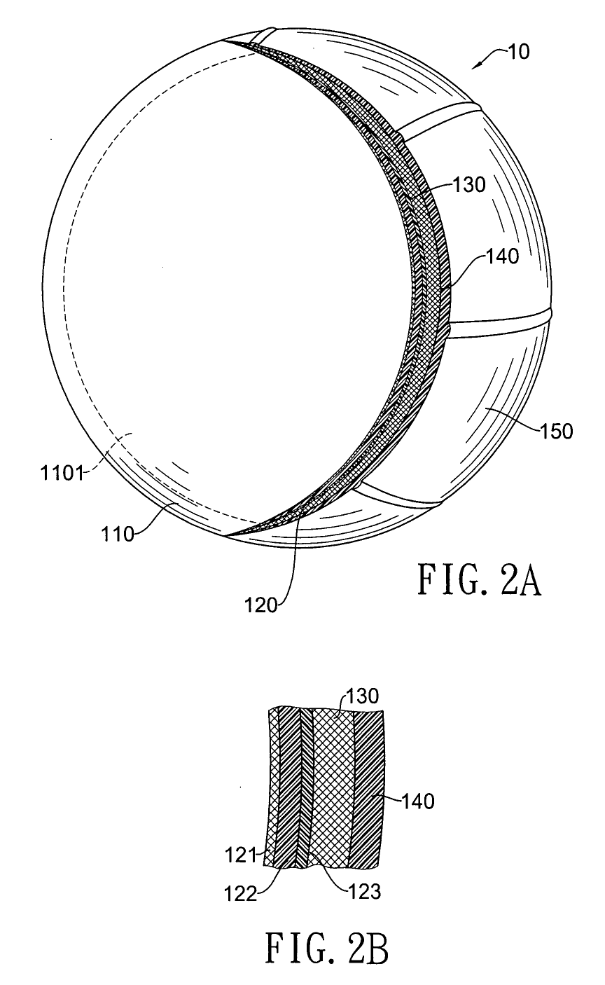

With reference to FIGS. 2A and 2B, an airtight ball (10) in accordance with the present invention comprises an inner bladder (110), a sealing layer (120), a wound layer (130), a rubber layer (140) and an outer leather covering (150).

The inner bladder (110) is a hollow, resilient sphere and has an inner space (1101) and an outer surface. The inner space (1101) is inflated with air.

The sealing layer (120) is applied to the outer surface of the inner bladder (110) and has a rubber glue layer (121), a polyvinyl alcohol (PVOH) layer (122) and a rubber balloon (123).

The rubber glue layer (121) fills air bubbles or holes in the outer surface of the inner bladder (110).

The a PVOH layer (122) is applied to the rubber glue layer (121) and forms a thin, resilient and airtight membrane to further reduce leakage of air from the inner space (1101) of the inner bladder (110). The PVOH layer (122) is specifically in preventing the leakage of CO₂, O₂, NO₂ or the combination thereof.

The rubber balloon (123) is formed of thin rubber, is mounted on the PVOH layer (122) and further stabilizes the inner bladder (110) to maintain roundness and increase bouncing ability of the ball (10).

The wound layer (130) is mounted on the rubber balloon (123) that keeps the wound layer (130) from cutting the PVOH layer (122), increases strength of the ball (10) and keeps the ball (10) from deforming.

Optionally, the wound layer (130) can be a nylon yarn-wound layer or a laminating cloth layer.

The rubber layer (140) is mounted on the wound layer (130).

The outer leather covering (150) is mounted on and covers the rubber layer (140).

The method of fabricating the airtight ball (10) comprises steps of obtaining an inner bladder (110), filling the inner bladder (110) with air, applying a layer of rubber glue, applying a layer of polyvinyl alcohol (PVOH), applying talcum powder, deflating the inner bladder (110), inserting the inner bladder (110) into the rubber balloon (123), inflating the inner bladder (110), applying the wound layer (130), mounting and vulcanizing the rubber layer (140) on the wound layer (130) and attaching the outer leather covering (150),

In the step of obtaining an inner bladder (110), the inner bladder (110) is hollow, resilient, spherical, inflatable and deflatable and has an outer surface.

In the step of applying a layer of rubber glue, the rubber glue is applied to the outer surface of the inner bladder (110) to form a rubber glue layer (121) and allowed to dry completely.

The step of applying a layer of PVOH is performed after the rubber glue layer (121) is completely dry and comprises applying a layer of PVOH to the rubber glue layer (121). Optionally, two concentrations of PVOH are prepared, and the thin PVOH is applied to the rubber glue layer (121). After the thin PVOH is dry, a layer of thick PVOH is applied to the dried thin PVOH. This step may be repeated a few times.

The step of applying talcum powder is performed after the PVOH layer (122) is completely dry and comprises applying talcum powder to the PVOH layer (122) on the surface of the inner bladder (110).

The step of deflating the inner bladder (110) removes as much air as possible from the inner bladder (110).

The step of inserting the inner bladder (110) into the rubber balloon (123) is facilitated by the talcum powder being on the PVOH layer (121).

The step of inflating the inner bladder (110) causes the inner bladder (110) to abut the rubber balloon (123).

The step of applying a wound layer (130) comprises winding a nylon yarn-wound layer or a laminating cloth layer on the rubber balloon (123).

The step of mounting and vulcanizing the rubber layer (140) on the wound layer (130) gives the ball (10) a proper size and shape.

The step of attaching the outer leather covering (150) to the vulcanized rubber layer (140) completes fabrication of the ball (10).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An airtight ball comprising
an inner bladder being a hollow, resilient sphere and having
an inner space being inflated with air; and
an outer surface;
a sealing layer being applied to the outer surface of the inner bladder and having
a rubber glue layer;
a polyvinyl alcohol (PVOH) layer being applied to the rubber glue layer and forming a thin, resilient and airtight membrane; and
a rubber balloon being formed of thin rubber and mounted on the PVOH layer;
a wound layer being mounted on the rubber balloon;
a rubber layer being mounted on the wound layer; and
an outer leather covering being mounted on and covering the rubber layer.

2. The airtight ball as claimed in claim 1, wherein the wound layer is a nylon yarn-wound layer.

3. The airtight ball as claimed in claim 1, wherein the wound layer is a laminated cloth layer.

4. A method of fabricating the airtight ball in claim 1, comprising steps of obtaining an inner bladder being hollow, resilient, spherical, inflatable and deflatable and having an outer surface;
inflating the inner bladder;
applying a rubber glue layer to the outer surface of the inner bladder and allowing the rubber glue layer to dry completely;
applying a layer of PVOH to the rubber glue layer and waiting until the PVOH layers are completely dry;
applying talcum powder to the PVOH layer;
deflating the inner bladder;
inserting the inner bladder into a rubber balloon;
inflating the inner bladder;
applying a wound layer on the rubber balloon;
mounting and vulcanizing a rubber layer on the wound layer; and
attaching an outer leather covering to the rubber layer.

5. The method as claimed in claim 4, wherein the wound layer is a nylon yarn-wound layer.

6. The method as claimed in claim 4, wherein the wound layer is a laminated cloth layer.

7. The method as claimed in claim 4, wherein the layer of PVOH further comprise two different concentrations.

8. The method as claimed in claim 4, wherein the step of applying the layer of PVOH comprises
applying thin PVOH on the surface of the rubber glue layer;
waiting until the thin PVOH is dry;
applying a layer of thick PVOH to the dried thin PVOH; and
repeating the foregoing step a few times.
